(19) United States
(12) Patent Application Publication
(10) Pub. No.: US 2026/0121153 A1
(43) Pub. Date: Apr. 30, 2026

(54) SECONDARY BATTERY

(71) Applicant: TOYOTA JIDOSHA KABUSHIKI KAISHA, Toyota-shi (JP)

(72) Inventor: Kodai MIYAZAKI, Toyota-shi (JP)

(73) Assignee: TOYOTA JIDOSHA KABUSHIKI KAISHA, Toyota-shi (JP)

(21) Appl. No.: 19/252,471

(22) Filed: Jun. 27, 2025

(30) Foreign Application Priority Data
Oct. 25, 2024 (JP) 2024-187997

(51) Int. Cl. H01M 10/653; H01M 10/613; H01M 10/615; H01M 10/647; H01M 10/654; H01M 10/6554; H01M 50/103; H01M 50/176; H01M 50/531

(52) U.S. Cl. CPC H01M 10/653; H01M 10/613; H01M 10/615; H01M 10/647; H01M 10/654; H01M 10/6554; H01M 50/103; H01M 50/176; H01M 50/531

(57) ABSTRACT

A secondary battery includes one or more battery cells. Each of the one or more battery cells includes a cell case, a plurality of electrode bodies, a current collector terminal, an external terminal, and a thermally conductive member. The electrode bodies are housed in the cell case. The current collector terminal is housed in the cell case, and electrically connected to the electrode bodies. The external terminal is electrically connected to the current collector terminal, and penetrates a first wall of the cell case to protrude out of the cell case. The thermally conductive member is interposed between adjacent electrode bodies, among the electrode bodies, and disposed in contact with each of the adjacent electrode bodies and the current collector terminal.

### CROSS-REFERENCE TO RELATED APPLICATION

This application claims priority to Japanese Patent Application No. 2024-187997 filed on Oct. 25, 2024. The disclosure of the above-identified application, including the specification, drawings, and claims, is incorporated by reference herein in its entirety.

### BACKGROUND

### 1. Technical Field

The present disclosure relates to a secondary battery.

### 2. Description of Related Art

Japanese Unexamined Patent Application Publication No. 2023-116166 (JP 2023-116166 A) discloses a battery module. The battery module includes a plurality of battery cells arranged in a first direction and each including a bottom surface, a cooling plate that faces the bottom surface of the battery cells, and a heat-conductive member provided between the battery cells and the cooling plate.

### SUMMARY

When the battery cells are being charged, the temperature of external terminals of the battery cells increases due to Joule heat. As a result, the temperature difference between the external terminals and a surrounding component (a wall of a cell case) and electrode bodies inside the cell case tends to become large. In a secondary battery, it is desirable that it should be possible to suppress such a temperature difference.

An aspect of the present disclosure provides a secondary battery including one or more battery cells. Each of the one or more battery cells includes a cell case, a plurality of electrode bodies, a current collector terminal, an external terminal, and a thermally conductive member. The electrode bodies are housed in the cell case. The current collector terminal is housed in the cell case, and electrically connected to the electrode bodies. The external terminal is electrically connected to the current collector terminal, and penetrates a first wall of the cell case to protrude out of the cell case. The thermally conductive member is interposed between adjacent electrode bodies, among the electrode bodies, and disposed in contact with each of the adjacent electrode bodies and the current collector terminal.

According to the present disclosure, heat generated at the external terminal during charging can be easily transmitted to the electrode bodies via the current collector terminal and the thermally conductive member. Therefore, it is possible to suppress the temperature difference between the external terminal and a surrounding component and the electrode bodies during charging.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view illustrating a schematic configuration of a battery cell included in a secondary battery according to an embodiment;

FIG. 2 illustrates the internal structure of the battery cell as viewed from the Y direction in FIG. 1;

FIG. 3 illustrates the internal structure of a battery cell according to a comparative example; and

FIG. 4 is a diagram for explaining the effect of the secondary battery according to the embodiment.

### DETAILED DESCRIPTION OF EMBODIMENTS

An embodiment of the present disclosure will be described with reference to the attached drawings. Elements common to the drawings are given the same reference numerals to omit or simplify redundant description.

### 1. Structure of Secondary Battery

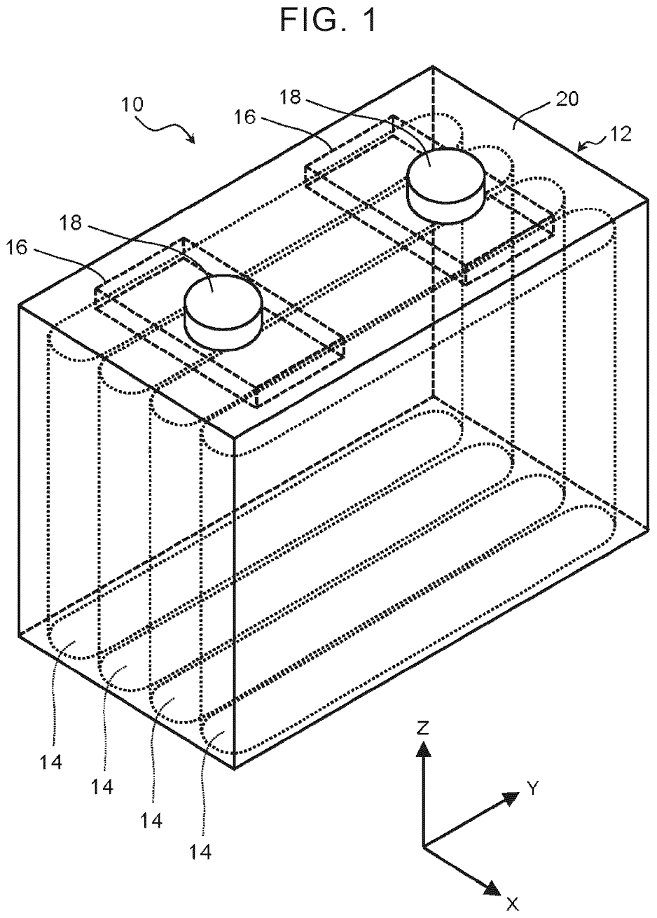

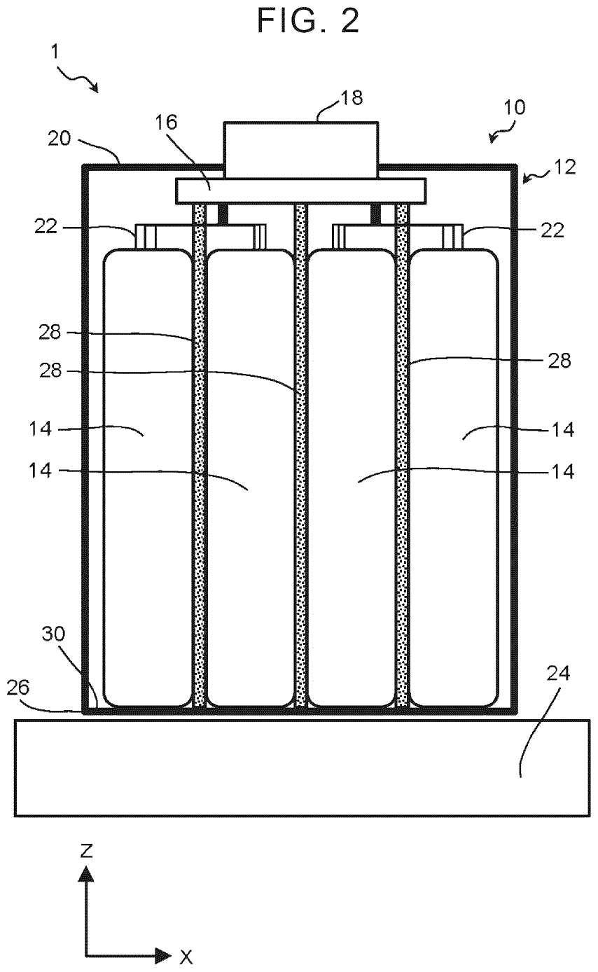

FIG. 1 is a perspective view illustrating a schematic configuration of a battery cell 10 included in a secondary battery 1 according to the present embodiment. The secondary battery 1 (see FIG. 2) includes one or more battery cells 10. The secondary battery 1 may include a battery module including a plurality of battery cells 10. The secondary battery 1 is mounted on a vehicle, for example, and supplies power to the vehicle. The battery cell 10 is a lithium ion battery, by way of example.

The battery cell 10 includes a cell case 12, a plurality of electrode bodies 14, a pair of current collector terminals (a positive current collector terminal and a negative current collector terminal) 16, and a pair of external terminals (a positive external terminal and a negative external terminal) 18. The cell case 12 has a rectangular parallelepiped shape, for example. The cell case 12 is formed from a metal material such as aluminum, for example. In FIG. 1, the Z direction is the height direction of the battery cell 10. The X direction is the direction of the short side of the cell case 12 perpendicular to the Z direction. The Y direction is the direction of the long side of the cell case 12 perpendicular to the Z direction.

The cell case 12 houses a plurality of (e.g., four) electrode bodies 14. The electrode bodies 14 are each formed in a plate shape. As illustrated in FIG. 1, the electrode bodies 14 are disposed side by side with their thickness direction aligned with the X direction, for example. The electrode bodies 14 are each formed to include a positive electrode and a negative electrode, and to hold an electrolyte between the positive electrode and the negative electrode. The electrode bodies 14 may be of a stacked type or a wound type.

FIG. 2 illustrates the internal structure of the battery cell 10 as viewed from the Y direction in FIG. 1, and more specifically, illustrates the internal structure of the battery cell 10 at the position of one of the external terminals (e.g., the positive external terminal) 18. The internal structure of the battery cell 10 at the position of the other external terminal (e.g., the negative external terminal) 18 is also similar to that illustrated in FIG. 2.

The cell case 12 houses the current collector terminals 16. Each of the electrode bodies 14 is electrically connected via a pair of electrode tabs (a positive electrode tab and a negative electrode tab) 22 to the current collector terminals 16 corresponding to the electrode tabs 22, respectively. An upper wall (first wall) of the cell case 12 located on the upper side in the Z direction (height direction) is formed as a lid 20, for example. The external terminals 18 are attached to the lid 20 in an electrically insulated state. The external terminals 18 are electrically connected to the current collector terminals 16 inside the cell case 12, and penetrate the lid 20 to protrude to the outside of the cell case 12.

The secondary battery 1 may include a temperature adjustment device 24. The temperature adjustment device 24 is disposed in contact with a bottom wall 26 (second wall) of the cell case 12 located on the opposite side of the lid 20 (first wall), for example. The temperature adjustment device 24 functions as a heater/cooler that heats and cools the electrode bodies 14 via the bottom wall 26. A thermally conductive member may be interposed between the bottom wall 26 and the temperature adjustment device 24. Alternatively, the temperature adjustment device 24 may be configured to function as only one of a heater and a cooler.

When the battery cell is being charged (particularly during rapid charging in which a large current flows), the temperature of the external terminals of the battery cell increases due to Joule heat. As a result, a temperature difference ΔT between the external terminals and a surrounding component (a wall (e.g., the lid) of the cell case) and the electrode bodies inside the cell case tends to become large. In addition, in a secondary battery mounted on a vehicle, the temperature difference ΔT can have the following effects. That is, in recent years, there has been an increasing demand to shorten the charging time for vehicles (e.g., battery electric vehicles (BEVs) and plug-in hybrid battery electric vehicles (PHEVs)) that include a secondary battery that can be externally charged. The charging current during rapid charging is determined based on the temperature of the electrode bodies of the battery cell for safety purposes, for example. When the temperature of the electrode bodies is low during rapid charging, measures may be taken to raise the temperature of the electrode bodies from the outside using a device such as the temperature adjustment device 24 described above, but it is difficult to effectively warm the electrode bodies due to the thermal resistance to the electrode bodies. Furthermore, when the temperature of the external terminals increases due to Joule heat as described above, the heat is easily transferred from the external terminals to the side of the wall (e.g., the lid) having a low thermal resistance. As a result, a protective function that suppresses the charging current may be activated due to a rise in temperature at the position of a battery temperature sensor attached to the wall. This has a detrimental effect on the shortening of the charging time.

In the secondary battery, it is desirable that it should be possible to suppress the above-mentioned temperature difference ΔT. Thus, the battery cell 10 included in the secondary battery 1 according to the present embodiment further includes a thermally conductive member 28.

As illustrated in FIG. 2, the thermally conductive member 28 is interposed between adjacent electrode bodies 14. More specifically, in the example of the battery cell 10 illustrated in FIG. 2, there are three sets of adjacent electrode bodies 14. The thermally conductive member 28 is interposed between the adjacent electrode bodies 14 in each of the three sets, by way of example. The thermally conductive member 28 is disposed in contact with each of the adjacent electrode bodies 14 in each set and the current collector terminals 16. More specifically, each thermally conductive member 28 is disposed in contact with each of the current collector terminals 16. The current collector terminals 16 and each thermally conductive member 28 are in contact with each other by bonding or the like.

In the present embodiment, each thermally conductive member 28 is disposed also in contact with an inner wall surface 30 (the inner bottom surface of the cell case 12) of the bottom wall 26 (second wall) of the cell case 12. The bottom wall 26 and each thermally conductive member 28 are also in contact with each other by bonding or the like. As a result, each thermally conductive member 28 connects the current collector terminals 16 to the bottom wall 26 in the Z direction while being in contact with each of the adjacent electrode bodies 14.

The thermally conductive member 28 is formed in a sheet shape, by way of example. In the Z direction, one end of the thermally conductive member 28 formed in a sheet shape is in contact with each of the current collector terminals 16, and the other end of the thermally conductive member 28, located on the opposite side of the one end, is in contact with the bottom wall 26. In addition, when the battery cell 10 is viewed from the X direction in FIG. 1, the thermally conductive member 28 is disposed so as to entirely cover the surfaces of the adjacent electrode bodies 14 that face each other, by way of example.

The thermally conductive member 28 is formed from a material that is non-conductive and has a high thermal conductivity. More specifically, the thermally conductive member 28 has a higher thermal conductivity than the electrode bodies 14, for example. By way of example, the material is a fine ceramic such as aluminum nitride or silicon carbide.

### 2. Effects

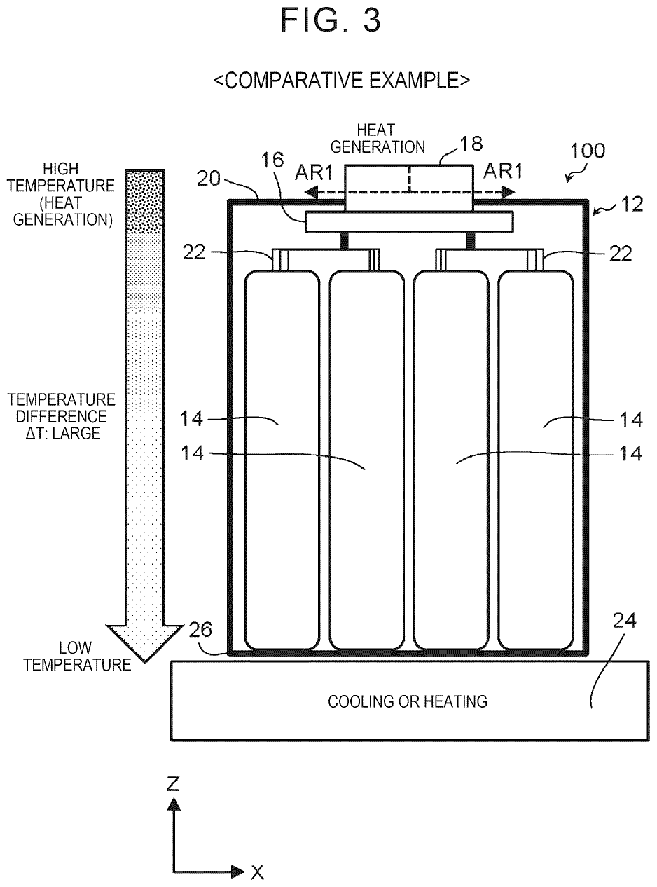

FIG. 3 illustrates the internal structure of a battery cell 100 according to a comparative example. The battery cell 100 according to the comparative example does not include the thermally conductive member 28, unlike the battery cell 10 according to the present embodiment. In other words, in the battery cell 100, there are fewer heat transfer paths from the external terminals 18 to the electrode bodies 14. Therefore, as described above as an issue, heat generated at the external terminals 18 during charging tends to escape to the side of the lid 20 (see the arrows AR1 in FIG. 3). As a result, as illustrated in FIG. 3, the temperature difference ΔT between the external terminals 18 and a surrounding component (the lid 20) and the electrode bodies 14 inside the cell case 12 becomes large.

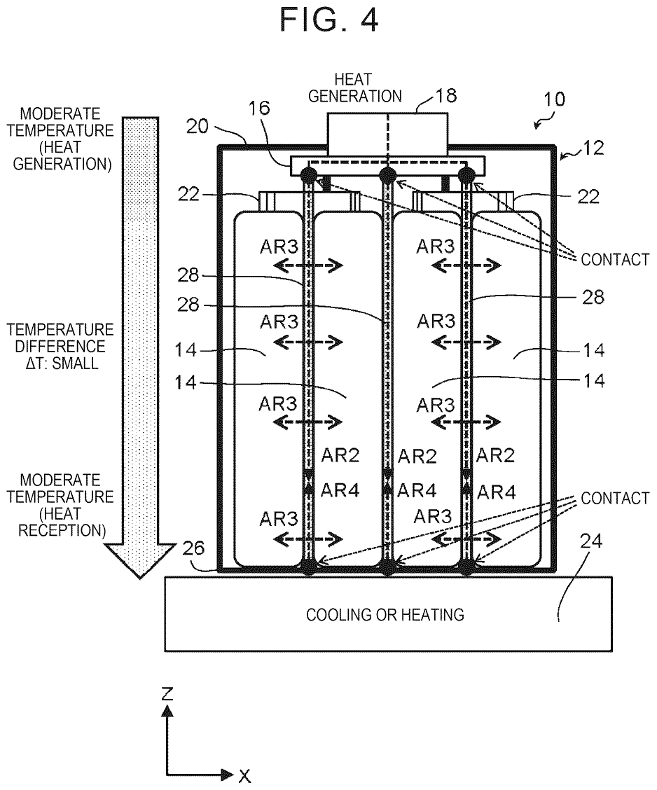

FIG. 4 is a diagram for explaining the effect of the secondary battery 1 according to the present embodiment. The battery cell 10 according to the present embodiment includes the thermally conductive member 28. As described above, the thermally conductive member 28 is interposed between the adjacent electrode bodies 14, and disposed in contact with each of the adjacent electrode bodies 14 and each of the current collector terminals. Consequently, as indicated by the arrows AR2 and AR3 in FIG. 4, the thermally conductive member 28 serves as a heat transfer path, effectively promoting the transport of heat generated at the external terminals 18 during charging to each part of the electrode bodies 14. As a result, as illustrated in FIG. 4, the temperature of the external terminals 18 and a surrounding component (the lid 20) is lower than in the comparative example. On the other hand, the temperature of the electrode bodies 14 rises due to the heat received from the side of the external terminals 18, and the variation in the temperature of each part of the electrode bodies 14 is suppressed. In this way, the battery cell 10 including the thermally conductive member 28 can effectively suppress the temperature difference ΔT by effectively utilizing the heat generated by the external terminals 18 during charging. Furthermore, suppression of the temperature difference ΔT leads to a reduction in the charging time (improvement of the charging efficiency) due to the improvement of the average current value during charging.

Broadly speaking, it is only necessary that the “thermally conductive member according to the present disclosure” should be disposed in contact with at least the current collector terminals 16, among the current collector terminals 16 and the bottom wall 26 (inner wall surface 30) of the cell case 12. Still, the thermally conductive member 28 according to the present embodiment is in contact with both the current collector terminals 16 and the bottom wall 26. That is, the thermally conductive member 28 connects the current collector terminals 16 to the bottom wall 26 while being in contact with each of the adjacent electrode bodies 14. This makes it easier to heat each part of the electrode bodies 14 uniformly by utilizing heat from the temperature adjustment device 24, as indicated by the arrows AR4 in FIG. 4. That is, the efficiency with which the temperature adjustment device 24 raises the temperature of the electrode bodies 14 is improved. This also leads to an improved charging efficiency. In addition, by including the thermally conductive member 28, the efficiency with which the temperature adjustment device 24 cools the electrode bodies 14 is also improved when the temperature of the electrode bodies 14 rises regardless of whether charging is being performed.

What is claimed is:

1. A secondary battery comprising one or more battery cells, wherein each of the one or more battery cells includes:
a cell case;
a plurality of electrode bodies housed in the cell case;
a current collector terminal housed in the cell case and electrically connected to the electrode bodies;
an external terminal electrically connected to the current collector terminal, the external terminal penetrating a first wall of the cell case to protrude out of the cell case; and
a thermally conductive member interposed between adjacent electrode bodies, among the electrode bodies, and disposed in contact with each of the adjacent electrode bodies and the current collector terminal.

2. The secondary battery according to claim 1, further comprising a temperature adjustment device that performs at least one of heating and cooling of the electrode bodies via a second wall of the cell case located on an opposite side of the first wall, wherein the thermally conductive member is disposed in contact with the second wall.

3. The secondary battery according to claim 1, wherein the thermally conductive member is in a sheet shape.

4. The secondary battery according to claim 1, wherein the thermally conductive member has a higher thermal conductivity than the electrode bodies.

5. The secondary battery according to claim 4, wherein the thermally conductive member is made of a fine ceramic.
